(19) United States
(12) Patent Application Publication
(10) Pub. No.: US 2023/0297743 A1
(43) Pub. Date: Sep. 21, 2023

(54) DEEP NEURAL NETWORKS FOR SYNTHESIS AND OPTIMIZATION OF SMOOTH SURFACED 3D OBJECTS

(71) Applicant: Siemens Aktiengesellschaft, Munich (DE)

(72) Inventors: Wei Chen, Evanston, IL (US); Arun Ramamurthy, Plainsboro, NJ (US)

(73) Assignee: Siemens Aktiengesellschaft, Munich (DE)

(21) Appl. No.: 17/999,941

(22) PCT Filed: Jun. 2, 2021
(86) PCT No.: PCT/US2021/035391

§ 371 Date: Nov. 28, 2022

Related U.S. Application Data
(60) Provisional application No. 63/033,235, filed on Jun. 2, 2020.

(51) Int. Cl. G06F 30/27; G06N 3/045; G06N 3/0464; G06N 3/0475; G06N 3/094

(52) U.S. Cl. CPC G06F 30/27; G06N 3/045; G06N 3/0464; G06N 3/0475; G06N 3/094

(57) ABSTRACT

A system and method for synthesis and optimization of smoothed surfaced three-dimensional (3D) objects uses a trainable generative adversarial network (GAN). A generator network of the GAN includes a deconvolutional neural network configured to receive a latent vector and to generate control points and weights. A Bézier layer in the generator uses the control points and weights to generate surface points of a simulated 3D surface according to a parametric Bézier curve. A GAN discriminator network includes a convolutional neural network configured to discriminate between generated surface points and surface points corresponding to training data stored in a database. The convolutional network also predicts latent vector statistics through convolution of parameters.

### TECHNICAL FIELD

This application relates to computer aided design. More particularly, this application using deep neural networks for synthesis and optimization of smooth surfaced three-dimensional (3D) objects.

### BACKGROUND

Traditionally, designs of smooth surfaced 3D objects (e.g., aerodynamic objects, hydrodynamic objects, airfoils, etc.) are parameterized by class and shape transformation (CST), free-form deformation (FFD), or B-spline volumes, which unnecessarily have large numbers of parameters, because most of the volume in the parameter space (design space) contains infeasible designs. Thus, optimization in the parameter space is extremely expensive and problematic due to its high-dimensionality and multimodality.

For the problem of reducing design variables in design optimization, one known method uses linear decomposition (i.e., singular value decomposition) on a sectional deformation and then applies a fixed planform to generate the complete 3D structure. Although this approach addresses the dimensionality reduction problem for 3D smooth surfaced structures, it actually applies dimensionality reduction only in the 2D domain.

Prior works have employed a Bézier-GAN approach for reducing 2D dimensionality that can efficiently parameterize 2D airfoils via a deep neural network. The Bézier-GAN approach can accelerate 2D airfoil optimization by an order of magnitude comparing to other commonly used 2D airfoil shape parameterization methods.

### SUMMARY

Apparatus and method are provided for synthesis and optimization of smoothed surfaced three-dimensional (3D) objects uses a trainable generative adversarial network (GAN). A generator network of the GAN includes a deconvolutional neural network configured to receive a latent vector and to generate control points and weights. A Bézier layer in the generator uses the control points and weights to generate surface points of a simulated 3D surface according to a parametric Bézier curve. A GAN discriminator network includes a convolutional neural network configured to discriminate between generated surface points and surface points corresponding to training data stored in a database. The convolutional network also predicts latent vector statistics through convolution of parameters.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 is a block diagram for an example of a system to synthesize and optimize smooth surfaced objects in 3D space in accordance with embodiments of the disclosure.

FIG. 2 shows an example of an architecture for a specialized generative adversarial network (GAN) used to synthesize and optimize aerodynamic objects in 3D space in accordance with embodiments of this disclosure.

FIG. 3 shows examples of training data for specialized GAN in accordance with embodiments of this disclosure.

FIG. 4 shows examples of designs randomly generated by specialized GAN in accordance with embodiments of this disclosure.

FIG. 5 shows examples of continuous deformation of design shapes during optimization in accordance with embodiments of this disclosure.

FIG. 6 illustrates an example of a computing environment within which embodiments of the present disclosure may be implemented.

### DETAILED DESCRIPTION

Methods and apparatuses are disclosed for synthesis and optimization of aerodynamic and hydrodynamic objects in 3D design space using a specialized generative adversarial network (GAN). Unlike prior works that solve for a 2D solution with linear design space dimensionality reduction (i.e., sectional geometry), the disclosed embodiments provide a framework that delivers a highly compact set of synthesized 3D valid designs while reducing design variables of the entire planform geometry. The specialized GAN includes a Bézier layer, whereby once trained, a narrow and focused set of 3D designs of aerodynamic and hydrodynamic objects are synthesized having the optimum surface smoothness. Performance of the specialized GAN is significantly superior than in prior works by reducing the number of required parameters for parameterizing 3D shapes to synthesize valid designs, accelerating the synthesis and reducing computational costs. Learned parameterizations according to the disclosed embodiments can achieve much higher compactness without a loss in representation quality or optimization performance.

Typical approaches to generative shape models (such as GANs) represent shapes as a collection of discrete samples (e.g., as pixels or voxels) owing to their original development in the computer vision community. For example, a naïve way of synthesizing aerodynamic shapes like airfoils would be to generate this discrete representation directly using the generator, such as generating a fixed number of coordinates sampled along the airfoil’s surface curve. To ensure substantial smoothness for satisfying requirements and design constraints for aerodynamic shapes, a specialized GAN is disclosed herein to include a Bézier layer that drives the control points for the design according to a parametric Bézier curve. The naive GAN representation of predicting discretized curves from the generator usually (1) creates noisy curves that have low smoothness and (2) have parametric output that is harder for humans to interpret and use in standard CAD packages compared to equivalent curve representations. This creates problems, particularly in aerodynamic shape synthesis. To solve this issue, the disclosed embodiments modify the GAN generator such that it only generates smooth shapes that conform to Bézier curves.

The disclosed embodiments relate to a specialized GAN that learns the distribution of 3D airfoil shapes. A vanilla GAN has two components: (1) a generator (G) that generates samples given any noise vectors drawn from a prior distribution; and (2) a discriminator (D) acting as a classifier that distinguishes whether any given samples are from the real database (real) or generated by the generator (fake). Both components improve during training via a minimax optimization (i.e., D minimizes the classification error and G maximizes the chance of a generated sample being misclassified).

Once trained properly, the generator can convert any random noise vector from a known distribution to a valid sample that resembles those in the database. Thus, essentially the generator can be considered as the parameterization for any sample it learned to generate (by using the noise vector as parameters). Also, since the neural networks can learn a highly non-linear mapping from the noise vector to the generated sample, we can make the noise space as compact as possible and hence serve the purpose of non-linear dimensionality reduction.

However, there are two issues if directly applying vanilla GAN for parameterizing airfoils: (1) it does not regularize the noise vector, so the noise space is disordered and non-interpretable, which is not favorable when using the noise vector as parameters for design space exploration or optimization; and (2) there is no guarantee that the surface points produced by the generator form a smooth surface, which is an important requirement for aerodynamic performance.

The first issue can be mitigated by the addition of a latent vector to serve the purpose of learning ordered and interpretable latent representation. Similar to the noise vector, the latent vector is also drawn from a prior distribution. Specifically, the generator G is conditioned on the latent vector, and the mutual information between the latent vector and the generated samples is maximized by letting D predict the original latent vector on which G is conditioned. The second issue is mitigated by the disclosed specialized GAN by using a 3D Bézier layer in the generator G to produce smooth 3D surfaces, as will be described in further detail below.

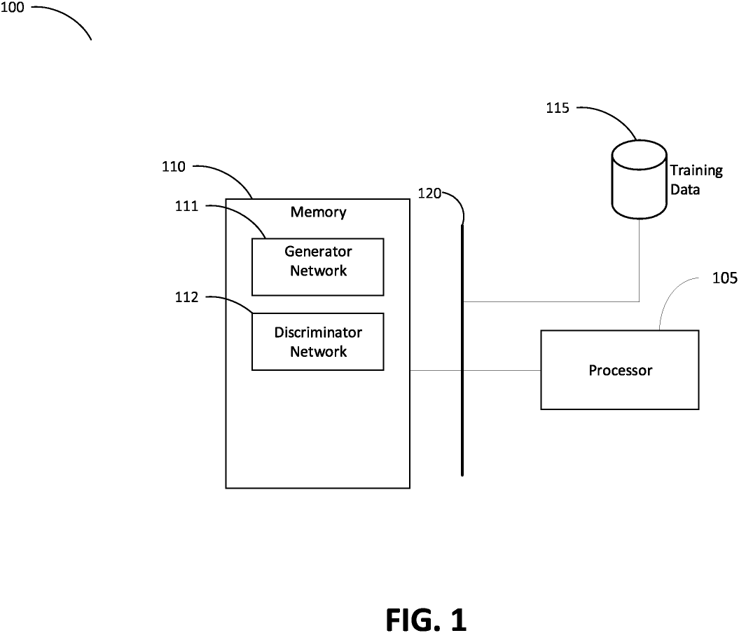

FIG. 1 shows a block diagram of a system to synthesize and optimize smooth surfaced objects in 3D space the embodiments of this disclosure. A computing system 100 includes a memory 110, a system bus 120, and a processor 105. A generator network 111 is a neural network stored as a program module in memory 110. Discriminator 112 is a neural network stored as a program module in memory 120. Processor 105 executes the modules 111, 112 to perform the functionality of the disclosed embodiments. Training data 115 used to train the neural networks may be stored locally or may be stored remotely, such as in a cloud-based server. Training data may include real depth images obtained from a depth scan sensor or camera, artificial noise, and computer aided design (CAD) generated depth images. In an alternative embodiment, generator network 111 and discriminator network 112 may be deployed in a cloud-based server and accessed by computing system 100 using a network interface.

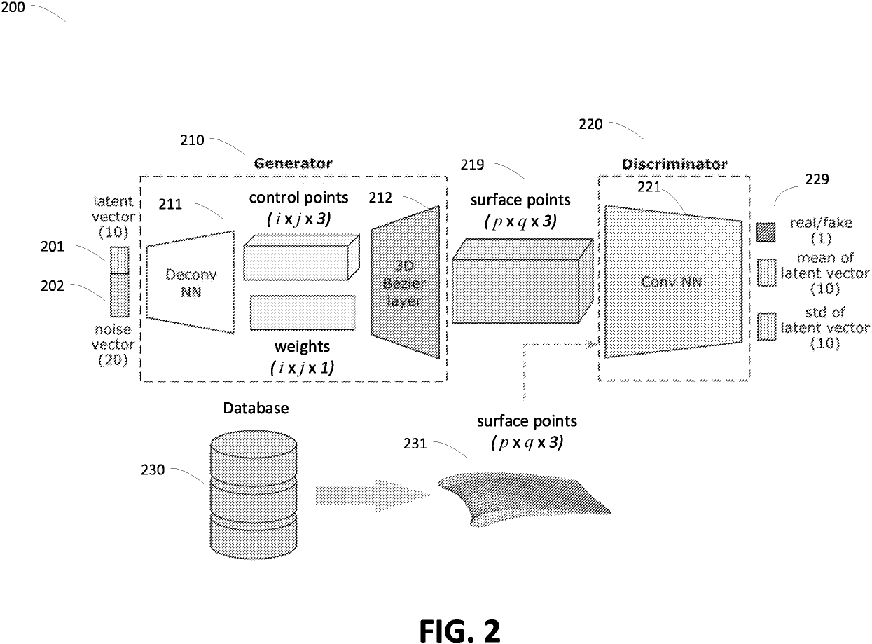

FIG. 2 shows an example of an architecture for a specialized generative adversarial network (GAN) used to synthesize and optimize aerodynamic objects in 3D space in accordance with embodiments of this disclosure. An example of a specialized GAN 200 is shown, having a generator 210 and a discriminator 220, which correspond with generator network 111 and discriminator network 112 of FIG. 1. Generator 210 includes a deconvolutional neural network 211 and a 3D Bezier layer 212. In an embodiment, GAN 200 is trained with training data based on designs stored in database 230 being fed to discriminator 220. During training of GAN 200, a latent vector 201 and noise vector 202 are concatenated and applied as input to generator 210.

The latent vector 201 provides a mechanism for regularizing the latent representation (e.g., noise) for the generator 210. Because standard GANs are not capable of such regularization, the noise input may end up being non-interpretable. Consequently, noise variation may not reflect an intuitive design variation and can impede design space exploration. To compensate for this weakness, the specialized GAN 200 encourages interpretable and disentangled latent representations by maximizing the mutual information between latent vector 201 and the generated surface points 219. The discriminator 220 performs an auxiliary distribution using convolutional network 221 to predict the latent vector in output 229. For example, latent vector statistics can be predicted, such as a mean of latent vector and a standard of latent vector. Through multiple training iterations of GN 200, the latent vector can be optimized using the latent vector statistics. The GAN 200 guarantees statistical independence among latent variables 201 or noise variables 202 when each variable is independently sampled. In an embodiment, the optimization of the designs produced by generator 210 is controlled by defining the latent vector variables. In an aspect, the required latent vector size can be small and can still allow the generator 210 to yield quality results with objects 219 that accurately represent training objects 231. For example, latent vector is defined by a small set of variables (e.g., 10 variables as shown in FIG. 2) to provide the generator 210 with input variable 201 that can generate a reduced size parameter set in control points and weights (i.e., size of i x ⱼ), without sacrificing quality of generated object surface points 219. In an embodiment, a subset of latent vector variables is used to control the control points while keeping one or more latent variables fixed during training of the specialized GAN 200.

The deconvolutional neural network 211 generates control points {pᵢⱼli = 0, ...,m; j = 0, ..., n} and weights {wᵢⱼ|i = 0, ...,m;j = 0, ..., n} of a rational Bézier surface. The rational Bézier representation (i.e., the choice of P, w) for a point sequence is not unique. For example, the generated control points can become dispersed and disorganized. In some instances, the weights vanish at control points far away from the surface points, and Bézier parameter variables have to become highly non-uniform to adjust the ill-behaved control points. To prevent the specialized GAN 200 from converging to bad optima, regularization is performed using generator regularization terms R(G) for the generator 210. One way to regularize control points is to keep them close together. In an aspect, the average and maximum Euclidean distance between each two adjacent control points is used as a first regularization term R1, and can be expressed as follows:

$$\left|{R}_{1} \left(G\right)\right) = \frac{1}{N n} {\sum }_{x = 1}^{N} {\sum }_{l = 1}^{n} \left‖{P}_{i}^{\left(s\right)} - {P}_{l - 1}^{\left(x\right)}\right‖ ,$$

where N is the sample size.

To eliminate the effects of redundant control points and avoid convoluted curves, a second regularization term R2 is used to regularize the weights and control points except for the first and the last ones, which can be expressed as follows:

$${R}_{2} \left(G\right) = \frac{1}{N n} {\sum }_{x = 1}^{N} {\sum }_{i = 1}^{n - 1} \left|{w}_{i}^{\left(s\right)}\right| .$$

To enforce edge alignment of the aerodynamic surface, ensuring that starting and ending points of a trailing edge meet together (e.g., for a representation that forms an airfoil by folding the surface at a leading edge), a third regularization term R3 is defined for the first and last control points P0 and Pn, which can be expressed as follows:

$${R}_{y} \left(G\right) = \frac{1}{N} {\sum }_{s = 1}^{N} \left‖{P}_{0}^{\left(x\right)} - {P}_{n}^{\left(x\right)}\right‖ .$$

As additional edge alignment regularization to ensure that the surface curve does not self-intersect near the trailing edge, a fourth regularization term R4 operates on a y coordinate of the first and last control points, which can be expressed as follows:

$${R}_{4} \left(G\right) = \frac{1}{N} {\sum }_{i = 1}^{N} max \left\{{0}_{i} - 10 \left({P}_{0 y}^{\left(x\right)} - {P}_{n y}^{\left(s\right)}\right)\right\} ,$$

where P_{iy} denotes the y-coordinate of the i-th control point in the j-th airfoil sample. With the above regularization terms R1-R4, the loss function of for the Bezier layer can be based on a weighted sum of the regularization terms.

Control points are fed into the 3D Bézier layer 212 as a (ixjx3) control point vector. In an embodiment, the control point vector defines a three-variable tensor with shape ixjx3, with the third variable representing three spatial dimensions x, y, z. One dimensional weights are input as a tensor with shape i×j×1. The 3D Bézier layer 212 is configured to produce a discrete surface point representation x:

$$x \left(u , v\right) = \frac{{\sum }_{i = 0}^{m} {\sum }_{j = 0}^{n} {P}_{i j} {w}_{i j} {B}_{i}^{m} \left(u\right) {B}_{j}^{n} \left(v\right)}{{\sum }_{i = 0}^{m} {\sum }_{j = 0}^{n} {w}_{i j} {B}_{i}^{m} \left(u\right) {B}_{j}^{n} \left(v\right)}$$

where u and v are defined by equally spaced parametric coordinates, and

$${B}_{i}^{m} \left(u\right) =$$

$$\left(\begin{matrix}n \\ i\end{matrix}\right) {u}^{i} {\left(1 - u\right)}^{n - 1} .$$

The discrete surface points 219 are a representation of a simulated aerodynamic object as a three-dimensional (3D) mesh with dimension (p x q x 3). This mesh can be defined by a foldable two-dimensional (p x q) surface. For example, a 3D airfoil object representation can be defined as a two-dimensional (p x q) surface folded over on itself, such as object visualization 231. In an aspect, the object can be defined as having p 2D cross sections of the object and q points along each of the p cross sections, and a 3D spatial variable for each point (p, q) on the surface.

During training, the discriminator 220 alternates between taking inputs of surface points 219 and surface points 231 corresponding to an object design representation stored in database 230. The discriminator 220 includes a convolutional neural network 221 configured to predict the statistics of the latent vector 201 and to discriminate whether surface point inputs come from the generator 210 or the database 230, by convolution of network 221 parameters. The coordinates of surface points 219 are represented as a tensor with shape pxqx3. These coordinates are treated as an image with three channels and a 2D convolution in the discriminator 220 is executed to extract its features and make predictions.

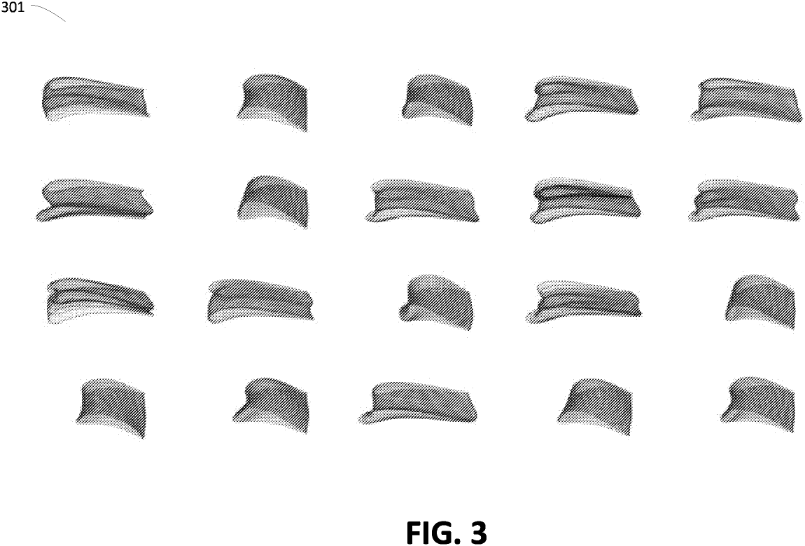

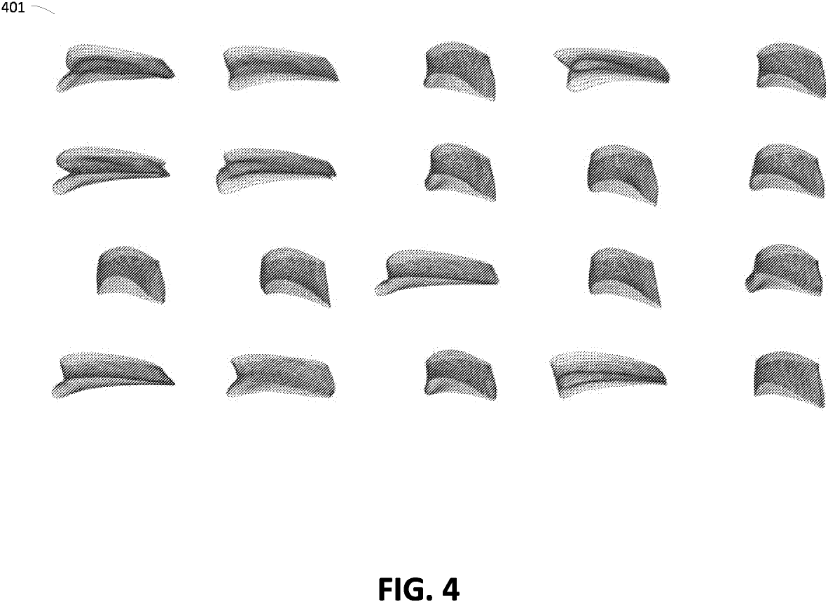

FIG. 3 shows examples of training data for specialized GAN 200 in accordance with embodiments of the disclosure. In an embodiment, training data for the specialized GAN 200 corresponds to shapes designed conventionally by a CAD user, such as shapes 301. For the example illustrated in FIG. 3, GAN 200 is implemented to simulate 3D airfoils. In an aspect, training data is stored in database 230. FIG. 4 shows examples of designs 401 randomly generated by generator 210 during training with the 3D airfoil training data shown in FIG. 3 shown as 3D visualizations 301. As can be seen, the quality of designs 401 generated by the trained specialized GAN is equivalent to the training set 301 generated by CAD and retrieved from the training database.

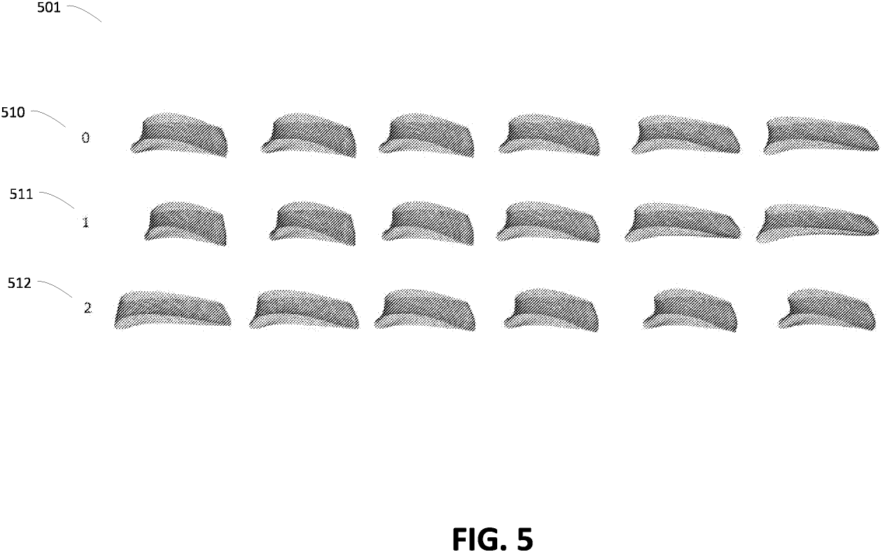

FIG. 5 illustrates the continuous deformation of design shapes during optimization in accordance with embodiments of this disclosure. In an embodiment, the latent vector is varied along some dimensions while fixing other dimensions. As shown, three sets of airfoil deformations 501 are generated, corresponding to shape visualizations of surface points 219. In an embodiment in which latent vector has a dimension (size) of 10 variable latent codes c {c0, c1, c2, ..., c9}, a first set of shapes 510 is generated by varying latent code c0, a second set shapes 511 is generated by varying latent code c1, and a third set shapes 512 by varying latent code c2. In this example, only the first three latent codes are varied (i.e., moving the latent vectors along the first three latent dimensions) and fixing the remaining latent variable codes and noise vector to zero. As shown, the latent space (i.e., the space of the latent vectors) for the generated designs 510, 511, 512 is ordered and interpretable, where each results of controlling the generator through latent vector variables is easily interpretable by visual inspection. This property is highly favorable for the application of design space exploration and optimization.

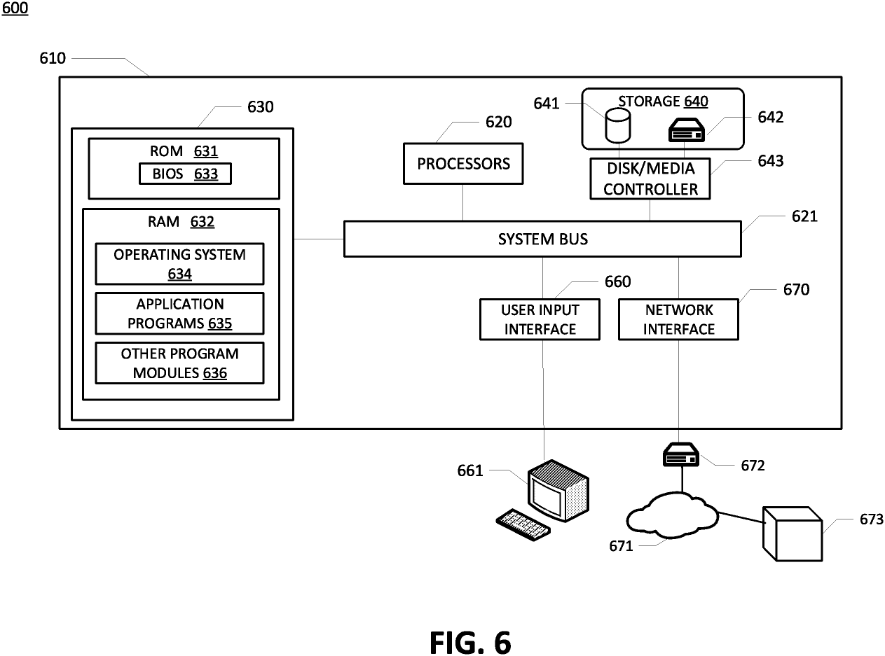

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. In an embodiment, computing environment 600 corresponds to system 100 as shown in FIG. 1 for synthesis and optimization of smooth surfaced 3D objects, in which the computer system 610 relates to a computer described below in greater detail.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application modules 635, and other program modules 636. Application modules 635 other program modules may include aforementioned mesh generator network 111, and discriminator network 112 shown in FIG. 1 and may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may include a user input interface 660 for communication with a graphical user interface (GUI) 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 673. The network interface 670 may enable communication, for example, with other remote devices 673 or systems and/or the storage devices 641, 642 via the network 671. Remote computing device 673 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 673). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (APl(s)), or any other suitable computer-executable code hosted locally on the computer system 610, the remote device 673, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for synthesis and optimization of smoothed surfaced three-dimensional objects, comprising:
a memory having modules stored thereon; and
a processor for performing executable instructions in the modules stored on the memory, the modules comprising:
a generator network comprising:
a deconvolutional neural network configured to receive a latent vector and to generate control points and weights; and
a Bézier layer configured to generate surface points of a simulated three-dimensional surface according to a parametric Bézier curve based on the control points and weights; and
a discriminator network comprising:
a convolutional neural network configured to discriminate between generated surface points and surface points corresponding to training data stored in a database;
wherein the generator and discriminator form a trainable generative adversarial network,
wherein the convolutional network is configured to predict latent vector statistics through convolution of parameters.

2. The system of claim 1, wherein control of optimization for the 3D design includes defining the latent vector with a subset of variables to control the control points while keeping one or more latent variables fixed during training of the generative adversarial network.

3. The system of claim 1, wherein the control points are defined by a (i x j x 3) control point vector and the weights are defined by a (i x j x 1) weight vector.

4. The system of claim 3, wherein the control point vector defines a three-variable tensor with shape (i x j x 3) and the third variable representing three spatial dimensions (x, y, z).

5. The system of claim 4, wherein the Bézier layer is configured to produce a discrete surface point representation as a function of equally spaced parametric coordinates.

6. The system of claim 5, wherein the surface points are a representation of a simulated aerodynamic object as a three-dimensional mesh with dimension (p x q x 3).

7. The system of claim 6, wherein the mesh is defined by a foldable two-dimensional (p x q) surface.

8. The system of claim 5, wherein the surface points are defined as having p 2D cross sections of the simulated aerodynamic object and q points along each of the p cross sections, and a three-dimensional spatial variable for each point (p, q) on the surface.

9. A method for synthesis and optimization of smoothed surfaced three-dimensional objects, comprising:
receiving, by a deconvolutional neural network of a generative adversarial network generator, a latent vector;
generating, by the deconvolutional neural network, control points and weights;
generating, by a Bézier layer of the generator, surface points of a simulated three-dimensional surface according to a parametric Bézier curve based on the control points and weights;
discriminating, by a convolutional neural network of a discriminator of the generative adversarial network, between generated surface points and surface points corresponding to training data stored in a database;
wherein the convolutional network is configured to predict latent vector statistics through convolution of parameters.

10. The method of claim 9, wherein control of optimization for the 3D design includes defining the latent vector with a subset of variables to control the control points while keeping one or more latent variables fixed during training of the generative adversarial network.

11. The method of claim 9, wherein the control points are defined by a (i x j x 3) control point vector and the weights are defined by a (i x j x 1) weight vector.

12. The method of claim 11, wherein the control point vector defines a three-variable tensor with shape (i x j x 3) and the third variable representing three spatial dimensions (x, y, z).

13. The method of claim 12, wherein the Bézier layer is configured to produce a discrete surface point representation as a function of equally spaced parametric coordinates.

14. The method of claim 13, wherein the surface points are a representation of a simulated aerodynamic object as a three-dimensional mesh with dimension (p x q x 3), the mesh defined by a foldable two-dimensional (p x q) surface.

15. The method of claim 13, wherein the surface points are defined as having p 2D cross sections of the simulated aerodynamic object and q points along each of the p cross sections, and a three-dimensional spatial variable for each point (p, q) on the surface.
